(19) United States
(12) Patent Application Publication
(10) Pub. No.: US 2026/0081075 A1
(43) Pub. Date: Mar. 19, 2026

(54) MULTILAYER CERAMIC CAPACITOR

(71) Applicant: Murata Manufacturing Co., Ltd., Nagaokakyo-shi (JP)

(72) Inventors: Tomohiro SASAKI, Nagaokakyo-shi (JP); Tatsunori YASUDA, Nagaokakyo-shi (JP)

(21) Appl. No.: 19/215,435

(22) Filed: May 22, 2025

(30) Foreign Application Priority Data
Sep. 17, 2024 (JP) 2024-159854

(51) Int. Cl. H01G 4/232; H01G 4/012; H01G 4/12; H01G 4/30

(52) U.S. Cl. CPC H01G 4/232; H01G 4/012; H01G 4/12; H01G 4/30

(57) ABSTRACT

A multilayer ceramic capacitor includes a multilayer body including first, second, third, fourth, fifth, and sixth surfaces, and first, second, and third external electrodes extending in the layering direction. The multilayer body includes dielectric layers and first and second internal electrode layers respectively connected to the first external electrode and the second and third external electrodes. The first external electrode includes a first fold-back portion. The second external electrode includes a second fold-back portion and a third fold-back portion. The third external electrode includes a fourth fold-back portion and a fifth fold-back portion. A dimension in a second direction of the multilayer ceramic capacitor is greater than a dimension in a layering direction of the multilayer ceramic capacitor.

### CROSS REFERENCE TO RELATED APPLICATIONS

This nonprovisional application is based on Japanese Patent Application No. 2024-159854 filed with the Japan Patent Office on Sep. 17, 2024. The entire contents thereof are hereby incorporated herein by reference.

### BACKGROUND OF THE INVENTION

### 1. Field of the Invention

The present invention relates to multilayer ceramic capacitors.

### 2. Description of the Related Art

A bottom-electrode three-terminal capacitor that provides a shorter radio-frequency current path with a signal internal electrode and a GND internal electrode extending to a mount surface side is available as a capacitor lower in ESL than a conventional three-terminal multilayer ceramic capacitor.

A multilayer ceramic capacitor has recently provided an important role in a modern electronic device required to be mounted in a narrow space. Under such circumstances, while components have been reduced in size with the development of electronics, a higher capacitance has been demanded. A bottom-electrode three-terminal multilayer ceramic capacitor that can ensure a high capacitance while it is mounted in a narrow area has been demanded.

### SUMMARY OF THE INVENTION

Example embodiments of the present invention provide bottom-electrode multilayer ceramic capacitors that each have an increased capacitance even in a narrow space.

A multilayer ceramic capacitor according to an example embodiment of the present invention includes a multilayer body including a first surface and a second surface opposed to each other in a layering direction, a third surface and a fourth surface opposed to each other in a first direction orthogonal or substantially orthogonal to the layering direction, and a fifth surface and a sixth surface opposed to each other in a second direction orthogonal or substantially orthogonal to the layering direction and the first direction, a first external electrode extending in the layering direction at a central portion in the first direction of the fifth surface, a second external electrode extending in the layering direction at one end in the first direction of the fifth surface, and a third external electrode extending in the layering direction at an other end in the first direction of the fifth surface. The multilayer body includes a plurality of dielectric layers and a plurality of internal electrode layers. The plurality of internal electrode layers include a first internal electrode layer connected to the first external electrode and a second internal electrode layer connected to the second external electrode and the third external electrode. The first external electrode includes a first fold-back portion extending from the fifth surface to a portion of each of the first surface and the second surface. The second external electrode includes a second fold-back portion extending from the fifth surface to a portion of each of the first surface and the second surface and a third fold-back portion extending to a portion of the third surface. The third external electrode includes a fourth fold-back portion from the fifth surface to a portion of each of the first surface and the second surface and a fifth fold-back portion extending to a portion of the fourth surface. A dimension in the second direction of the multilayer ceramic capacitor is greater than a dimension in the layering direction of the multilayer ceramic capacitor.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view showing a multilayer ceramic capacitor according to an example embodiment of the present invention.

FIG. 2 is a front view showing an exemplary multilayer ceramic capacitor according to an example embodiment of the present invention.

FIG. 3 is a right side view showing an exemplary multilayer ceramic capacitor according to an example embodiment of the present invention.

FIG. 4 is a bottom view showing an exemplary multilayer ceramic capacitor according to an example embodiment of the present invention.

FIG. 5 is a schematic cross-sectional view along the line V-V in FIG. 2.

FIG. 6 is a schematic cross-sectional view along the line VI-VI in FIG. 2.

FIG. 7A is a schematic cross-sectional view along the line VIIA-VIIA in FIG. 3.

FIG. 7B is a schematic cross-sectional view along the line VIIB-VIIB in FIG. 3.

FIG. 8 is a perspective view illustrating an arrangement of internal electrode layers inside a multilayer body of a multilayer ceramic capacitor according to an example embodiment of the present invention.

FIG. 9A is a schematic cross-sectional view showing a first modification of a first internal electrode layer of a multilayer ceramic capacitor according to an example embodiment of the present invention.

FIG. 9B is a schematic cross-sectional view showing a first modification of a second internal electrode layer of a multilayer ceramic capacitor according to an example embodiment of the present invention.

FIG. 10Aa is a schematic cross-sectional view showing a second modification of a first internal electrode layer of a multilayer ceramic capacitor according to an example embodiment of the present invention.

FIG. 10Ab is a schematic cross-sectional view showing a third modification of a first internal electrode layer of a multilayer ceramic capacitor according to an example embodiment of the present invention.

FIG. 10Ac is a schematic cross-sectional view showing a fourth modification of a first internal electrode layer of a multilayer ceramic capacitor according to an example embodiment of the present invention.

FIG. 10Ad is a schematic cross-sectional view showing a fifth modification of a first internal electrode layer of a multilayer ceramic capacitor according to an example embodiment of the present invention.

FIG. 10Ba is a schematic cross-sectional view showing a second modification of a second internal electrode layer of a multilayer ceramic capacitor according to an example embodiment of the present invention.

FIG. 10Bb is a schematic cross-sectional view showing a third modification of a second internal electrode layer of a multilayer ceramic capacitor according to an example embodiment of the present invention.

FIG. 10Bc is a schematic cross-sectional view showing a fourth modification of a second internal electrode layer of a multilayer ceramic capacitor according to an example embodiment of the present invention.

FIG. 10Bd is a schematic cross-sectional view showing a fifth modification of a second internal electrode layer of a multilayer ceramic capacitor according to an example embodiment of the present invention.

### DETAILED DESCRIPTION OF THE EXAMPLE EMBODIMENTS

Example embodiments of the present invention will be described in detail below with reference to the drawings.

### 1. Multilayer Ceramic Capacitor

An exemplary multilayer ceramic capacitor 10 according to an example embodiment of the present invention will now be described.

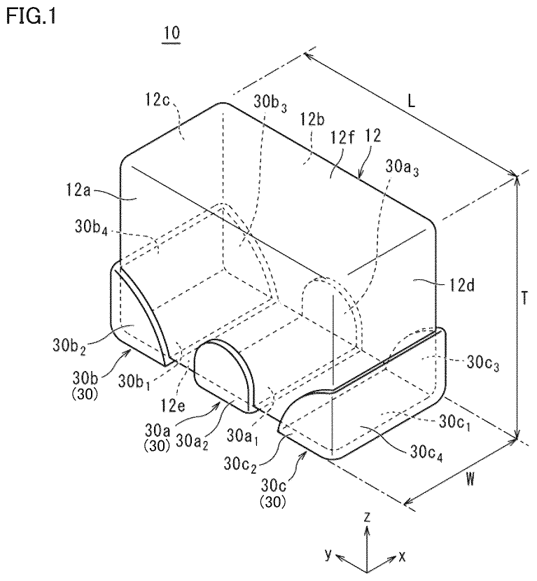

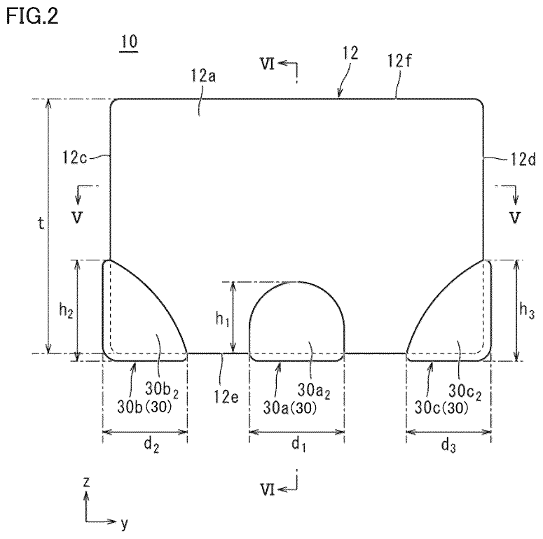

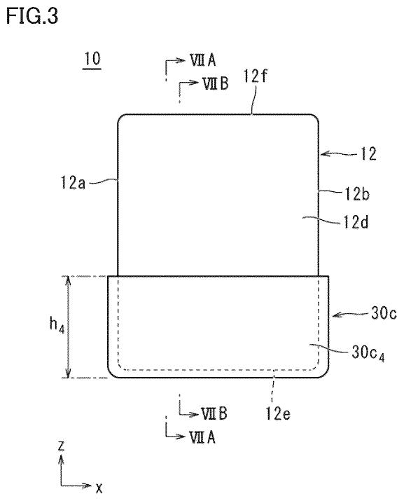

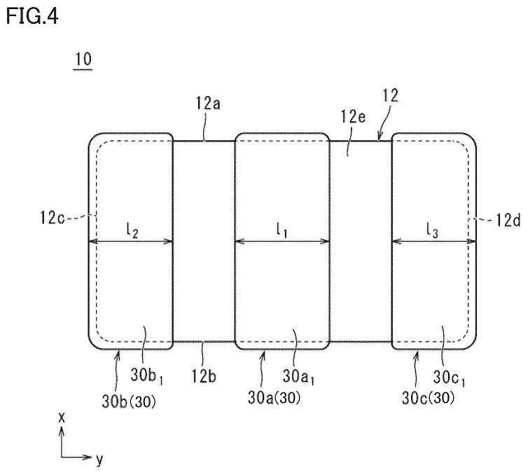

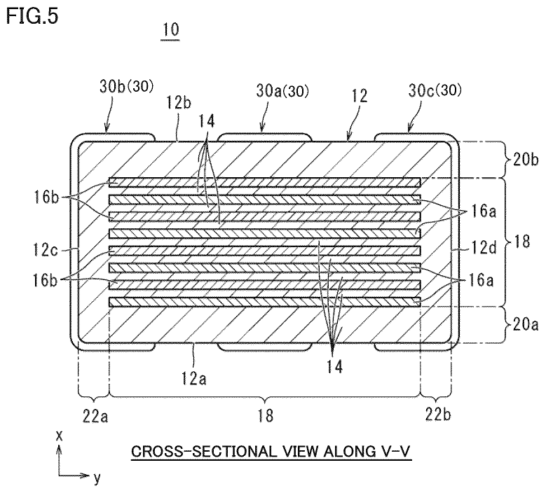

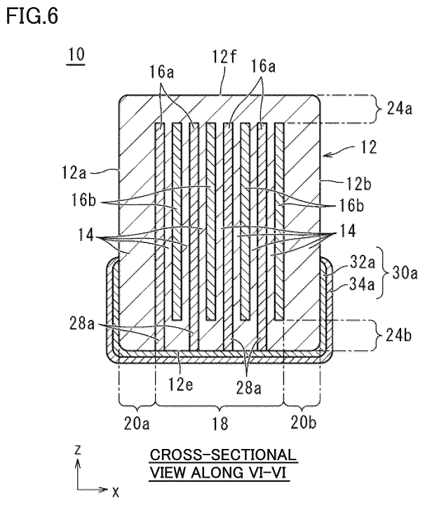

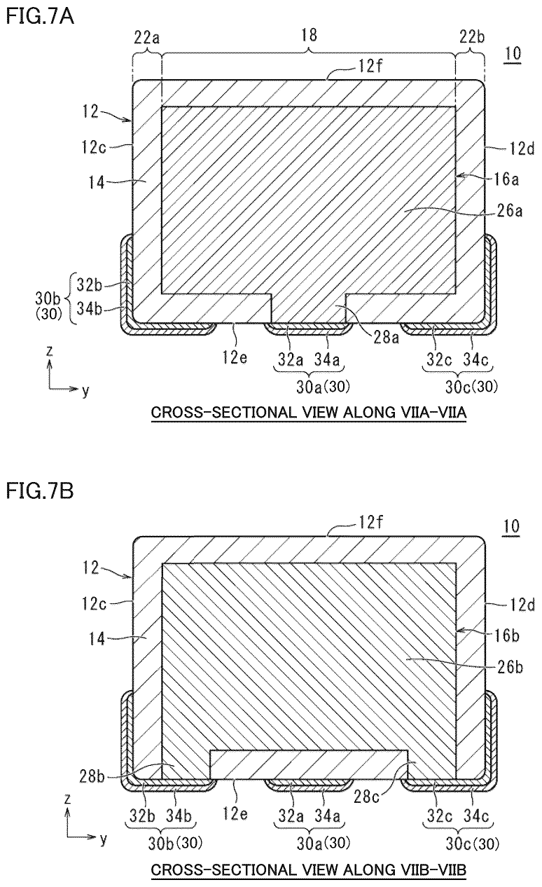

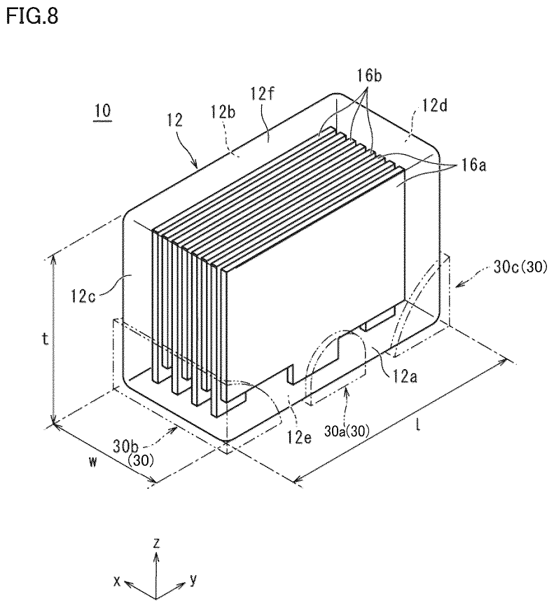

FIG. 1 is an external perspective view showing a multilayer ceramic capacitor according to the present example embodiment of the present invention. FIG. 2 is a front view showing an exemplary multilayer ceramic capacitor according to the present example embodiment of the present invention. FIG. 3 is a right side view showing an exemplary multilayer ceramic capacitor according to the present example embodiment of the present invention. FIG. 4 is a bottom view showing an exemplary multilayer ceramic capacitor according to the present example embodiment of the present invention. FIG. 5 is a schematic cross-sectional view along the line V-V in FIG. 2. FIG. 6 is a schematic cross-sectional view along the line VI-VI in FIG. 2. FIG. 7A is a schematic cross-sectional view along the line VIIA-VIIA in FIG. 3. FIG. 7B is a schematic cross-sectional view along the line VIIB-VIIB in FIG. 3. FIG. 8 is a perspective view illustrating an arrangement of internal electrode layers inside a multilayer body of the multilayer ceramic capacitor according to the present example embodiment of the present invention.

As shown in FIGS. 1 to 4, multilayer ceramic capacitor 10 includes, for example, a multilayer body 12 and an external electrode 30.

Multilayer body 12 includes a plurality of layered dielectric layers 14 and a plurality of internal electrode layers 16 layered on dielectric layers 14. Internal electrode layers 16 include a first internal electrode layer 16a and a second internal electrode layer 16b. Details of first internal electrode layer 16a and second internal electrode layer 16b will be described later.

Multilayer body 12 includes a first surface 12a and a second surface 12b opposed to each other in a layering direction x, a third surface 12c and a fourth surface 12d opposed to each other in a first direction y orthogonal or substantially orthogonal to layering direction x, and a fifth surface 12e and a sixth surface 12f opposed to each other in a second direction z orthogonal or substantially orthogonal to layering direction x and first direction y.

Multilayer body 12 has a shape of a parallelepiped and multilayer body 12 preferably includes a corner portion and a ridgeline portion that are rounded. The corner portion is a portion where three surfaces of multilayer body 12 meet one another and the ridgeline portion is a portion where two surfaces of multilayer body 12 meet each other. A portion or the entirety of first surface 12a and second surface 12b, third surface 12c and fourth surface 12d, and fifth surface 12e and sixth surface 12f may include irregularities or the like.

A dimension in first direction y of multilayer body 12 is defined as a l dimension, a dimension in second direction z of multilayer body 12 is defined as a t dimension, and a dimension in layering direction x of multilayer body 12 is defined as a w dimension. The t dimension of multilayer body 12 is larger than the w dimension thereof.

Multilayer body 12 includes a capacitance generating portion 18 and a first outer layer portion 20a located on a side of first surface 12a and a second outer layer portion 20b located on a side of second surface 12b, first outer layer portion 20a and second outer layer portion 20b being arranged such that capacitance generating portion 18 is disposed therebetween in layering direction x.

In capacitance generating portion 18, first internal electrode layer 16a and second internal electrode layer 16b are alternately layered with dielectric layer 14 being interposed therebetween.

First outer layer portion 20a is located on the side of first surface 12a of multilayer body 12 and includes a plurality of dielectric layers 14 located between first surface 12a and capacitance generating portion 18 closest to first surface 12a. Second outer layer portion 20b is located on the side of second surface 12b of multilayer body 12 and includes a plurality of dielectric layers 14 located between second surface 12b and capacitance generating portion 18 closest to second surface 12b. Furthermore, a region between first outer layer portion 20a and second outer layer portion 20b is capacitance generating portion 18.

As shown in FIG. 6, multilayer body 12 includes an upper region 24a located between capacitance generating portion 18 and sixth surface 12f and a lower region 24b located between capacitance generating portion 18 and fifth surface 12e and including a first drawn portion 28a of first internal electrode layer 16a and a second drawn portion 28b and a third drawn portion 28c of second internal electrode layer 16b.

As shown in FIG. 5, multilayer body 12 includes an end region 22a located between capacitance generating portion 18 and third surface 12c and an end region 22b located between capacitance generating portion 18 and fourth surface 12d.

Dielectric ceramic including, for example, BaTiO₃, CaTiO₃, SrTiO₃, or CaZrO₃ can be used as a ceramic material for dielectric layer 14. A material obtained by adding a sub component such as, for example, an Mn compound, an Fe compound, a Cr compound, a Co compound, or an Ni compound to these main components may be used.

A thickness of dielectric layer 14 is, for example, preferably not smaller than about 0.40 μm and not larger than about 0.75 μm. The number of layered dielectric layers 14 is, for example, preferably not smaller than 320 and not larger than 1020. This number of dielectric layers 14 is a total of the number of dielectric layers 14 in capacitance generating portion 18 and the number of dielectric layers 14 in first outer layer portion 20a and second outer layer portion 20b.

### Internal Electrode Layer

Internal electrode layer 16 includes first internal electrode layer 16a and second internal electrode layer 16b.

First internal electrode layer 16a is arranged on a plurality of dielectric layers 14. First internal electrode layer 16a extends to fifth surface 12e.

More specifically, as shown in FIG. 7A, first internal electrode layer 16a includes a first main portion 26a opposed to second internal electrode layer 16b and first drawn portion 28a extending from first main portion 26a to fifth surface 12e. First main portion 26a is located at a central portion on dielectric layer 14. First drawn portion 28a is exposed at fifth surface 12e of multilayer body 12. Therefore, first internal electrode layer 16a is not exposed at third surface 12c, fourth surface 12d, and sixth surface 12f of multilayer body 12. Although a shape of first main portion 26a and a shape of first drawn portion 28a are not particularly limited, the first main portion and the first drawn portion are, for example, preferably rectangular or substantially rectangular. First main portion 26a may include a corner portion that is rounded.

As shown in FIG. 7B, second internal electrode layer 16b includes a second main portion 26b opposed to first internal electrode layer 16a and second drawn portion 28b and third drawn portion 28c extending from second main portion 26b and to fifth surface 12e. Second main portion 26b is located at the central portion on dielectric layer 14. Second drawn portion 28b is exposed at fifth surface 12e on a side of third surface 12c. Third drawn portion 28c is exposed at fifth surface 12e on a side of fourth surface 12d. Therefore, second internal electrode layer 16b is not exposed at third surface 12c, fourth surface 12d, and sixth surface 12f of multilayer body 12. Although a shape of second main portion 26b and a shape of second drawn portion 28b and third drawn portion 28c are not particularly limited, the second main portion and the second drawn portion and the third drawn portion are, for example, preferably rectangular or substantially rectangular. Second main portion 26b may include a corner portion that is rounded.

First main portion 26a of first internal electrode layer 16a and second main portion 26b of second internal electrode layer 16b are opposed to each other. In the present example embodiment, first main portion 26a of first internal electrode layer 16a and second main portion 26b of second internal electrode layer 16b are opposed to each other with dielectric layer 14 being interposed therebetween, so that a capacitance is generated and characteristics of a capacitor are provided.

Although the number of first internal electrode layers 16a is not particularly limited, the number is preferably, for example, not smaller than 150 and not larger than 500. Although the number of second internal electrode layers 16b is not particularly limited, the number is preferably, for example, not smaller than 150 and not larger than 500. Therefore, the total number of first internal electrode layers 16a and second internal electrode layers 16b is, for example, preferably not smaller than 300 and not larger than 1000.

Although a thickness of first internal electrode layer 16a is not particularly limited, the thickness is preferably, for example, not smaller than about 0.38 μm and not larger than about 0.60 μm. Although a thickness of second internal electrode layer 16b is not particularly limited, the thickness is preferably, for example, not smaller than about 0.38 μm and not larger than about 0.60 μm.

A thickness of first drawn portion 28a is larger than a thickness of first main portion 26a. Preferably, a thickness of second drawn portion 28b is larger than a thickness of second main portion 26b and a thickness of third drawn portion 28c is larger than the thickness of second main portion 26b.

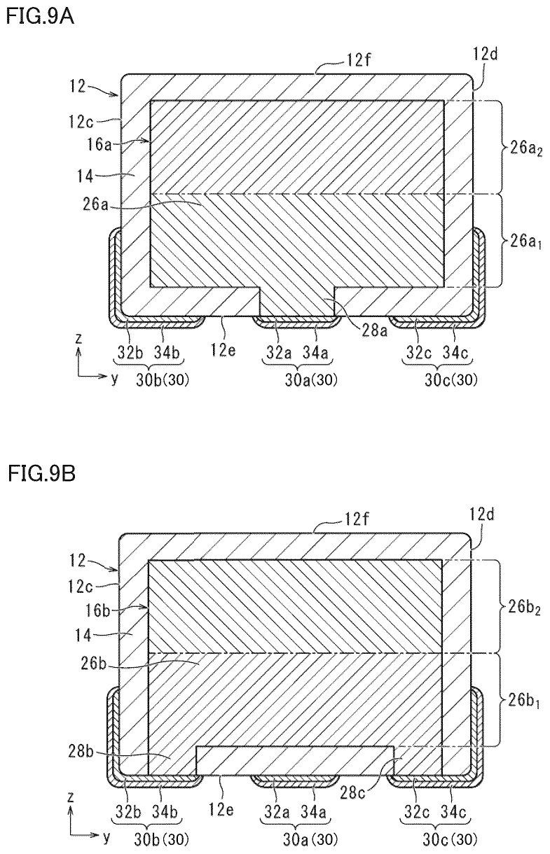

As shown in FIG. 9A, a thickness of a region located in first drawn portion 28a and a first lower main portion 26a₁ occupying a lower half region of first main portion 26a is preferably larger than a thickness of a first upper main portion 26a₂ occupying an upper half region of first main portion 26a.

Similarly, as shown in FIG. 9B, a thickness of a region located in second drawn portion 28b, third drawn portion 28c, and a second lower main portion 26b₁ occupying a lower half region of second main portion 26b is preferably larger than a thickness of a second upper main portion 26b₂ occupying an upper half region of second main portion 26b.

Furthermore, a rate of coverage (coverage) by a region of first drawn portion 28a of first internal electrode layer 16a, of dielectric layer 14 in a region corresponding to that region may be higher than a rate of coverage (coverage) by a region of first main portion 26a of first internal electrode layer 16a, of dielectric layer 14 in a region corresponding to that region. A rate of coverage (coverage) by respective regions of second drawn portion 28b and third drawn portion 28c of second internal electrode layer 16b, of dielectric layer 14 in regions corresponding to those regions may be higher than a rate of coverage (coverage) by a region of second main portion 26b of second internal electrode layer 16b, of dielectric layer 14 in a region corresponding to that region.

A rate of coverage (coverage) by a region located in first drawn portion 28a and first lower main portion 26a₁ occupying the lower half region of first main portion 26a of first internal electrode layer 16a, of dielectric layer 14 in a region corresponding to that region may be higher than a rate of coverage (coverage) by a region of first upper main portion 26a₂ occupying the upper half region of first main portion 26a of first internal electrode layer 16a, of dielectric layer 14 in a region corresponding to that region.

Furthermore, a rate of coverage (coverage) by a region located in second drawn portion 28b, third drawn portion 28c, and second lower main portion 26b₁ occupying the lower half region of second main portion 26b of second internal electrode layer 16b, of dielectric layer 14 in a region corresponding to that region may be higher than a rate of coverage (coverage) by a region in second upper main portion 26b₂ occupying the upper half region of second main portion 26b of second internal electrode layer 16b, of dielectric layer 14 in a region corresponding to that region.

First internal electrode layer 16a and second internal electrode layer 16b can be made, for example, of an appropriate conductive material such as, for example, Ni, Cu, Ag, Pd, or Au or an alloy including at least one of those metals, such as an Ag—Pd alloy.

Inclusion of, for example, an Sn layer between first internal electrode layer 16a and second internal electrode layer 16b, and dielectric layer 14 can relax concentration of electric field to an interface between internal electrode layer 16 and dielectric layer 14, which leads to an improvement in reliability against loads at a high temperature.

### External Electrode

External electrode 30 includes a first external electrode 30a, a second external electrode 30b, and a third external electrode 30c.

First external electrode 30a is arranged on fifth surface 12e. First external electrode 30a is connected to first drawn portion 28a of first internal electrode layer 16a. Furthermore, first external electrode 30a includes a first cover portion 30a₁ that covers first drawn portion 28a of first internal electrode layer 16a exposed at fifth surface 12e, a first fold-back portion 30a₂ provided in parallel or substantially in parallel to first internal electrode layer 16a on first surface 12a, and a second fold-back portion 30a₃ provided in parallel or substantially in parallel to first internal electrode layer 16a on second surface 12b.

Second external electrode 30b is arranged on fifth surface 12e. Second external electrode 30b is connected to second drawn portion 28b of second internal electrode layer 16b. Furthermore, second external electrode 30b includes a second cover portion 30b₁ that covers second drawn portion 28b of second internal electrode layer 16b exposed at fifth surface 12e, a third fold-back portion 30b₂ provided in parallel or substantially in parallel to second internal electrode layer 16b on first surface 12a, and a fourth fold-back portion 30b₃ provided in parallel or substantially in parallel to second internal electrode layer 16b on second surface 12b. Second external electrode 30b includes a fifth fold-back portion 30b₄ provided over a portion of third surface 12c.

Third external electrode 30c is arranged on fifth surface 12e. Third external electrode 30c is connected to third drawn portion 28c of second internal electrode layer 16b. Furthermore, third external electrode 30c includes a third cover portion 30c₁ that covers third drawn portion 28c of second internal electrode layer 16b exposed at fifth surface 12e, a sixth fold-back portion 30c₂ provided in parallel or substantially in parallel to second internal electrode layer 16b on first surface 12a, and a seventh fold-back portion 30c₃ provided in parallel or substantially in parallel to second internal electrode layer 16b on second surface 12b. Third external electrode 30c includes an eighth fold-back portion 30c₄ provided over a portion of fourth surface 12d.

A length h₁ in second direction z of first fold-back portion 30a₂ of first external electrode 30a is preferably longer than d₁/2 which is, for example, about ½ length of a length d₁ in first direction y of first fold-back portion 30a₂. Similarly, a length in second direction z of second fold-back portion 30a₃ of first external electrode 30a is preferably, for example, longer than about ½ length of a length in first direction y of second fold-back portion 30a₃.

Length h₁ in second direction z of first fold-back portion 30a₂ of first external electrode 30a is, for example, preferably not shorter than about ⅕ and not longer than about ½ of a length t (t dimension) in second direction z of multilayer body 12. Similarly, the length in second direction z of second fold-back portion 30a₃ of first external electrode 30a is, for example, preferably not shorter than about ⅕ and not longer than about ½ of length t (t dimension) in second direction z of multilayer body 12.

A length h₂ in second direction z of third fold-back portion 30b₂ of second external electrode 30b is preferably longer than a length d₂ in first direction y of third fold-back portion 30b₂. Similarly, a length in second direction z of fourth fold-back portion 30b₃ of second external electrode 30b is preferably longer than a length in first direction y of fourth fold-back portion 30b₃. A maximum length h₄ in second direction z of fifth fold-back portion 30b₄ of second external electrode 30b is preferably longer than length d₂ in first direction y of third fold-back portion 30b₂.

Length h₂ in second direction z of third fold-back portion 30b₂ of second external electrode 30b is, for example, preferably not shorter than about ⅕ and not longer than about ½ of length t (t dimension) in second direction z of multilayer body 12. Similarly, the length in second direction z of fourth fold-back portion 30b₃ of second external electrode 30b is, for example, preferably not shorter than about ⅕ and not longer than about ½ of length t in second direction z of multilayer body 12. Furthermore, maximum length h₄ in second direction z of fifth fold-back portion 30b₄ of second external electrode 30b is, for example, preferably not shorter than about ⅕ and not longer than about ½ of length t in second direction z of multilayer body 12.

A length h₃ in second direction z of sixth fold-back portion 30c₂ of third external electrode 30c is preferably longer than a length d₃ in first direction y of sixth fold-back portion 30c₂. Similarly, a length in second direction z of seventh fold-back portion 30c₃ of third external electrode 30c is preferably longer than a length in first direction y of seventh fold-back portion 30c₃. A maximum length in second direction z of eighth fold-back portion 30c₄ of third external electrode 30c is preferably longer than length d₃ in first direction y of sixth fold-back portion 30c₂.

Length h₃ in second direction z of sixth fold-back portion 30c₂ of third external electrode 30c is, for example, preferably not shorter than about ⅕ and not longer than about ½ of length t (t dimension) in second direction z of multilayer body 12. Similarly, the length in second direction z of seventh fold-back portion 30c₃ of third external electrode 30c is preferably not shorter than ⅕ and not longer than ½ of length t in second direction z of multilayer body 12. Furthermore, a maximum length in second direction z of eighth fold-back portion 30c₄ of third external electrode 30c is, for example, preferably not shorter than about ⅕ and not longer than about ½ of length t in second direction z of multilayer body 12.

A length l₁ in first direction y of first cover portion 30a₁ of first external electrode 30a located on fifth surface 12e is longer than a length l₂ in first direction y of second cover portion 30b₁ of second external electrode 30b and longer than a length l₃ in first direction y of third cover portion 30c₁ of third external electrode 30c.

With the configuration including the fold-back portions of each external electrode 30 as described above, when multilayer ceramic capacitor 10 including external electrode 30 on a bottom surface side as in the present example embodiment has a higher profile, a volume of external electrode 30 increases, and thus the center of gravity can be lowered and mountability of multilayer ceramic capacitor 10 can be further stabilized. In addition, by increasing the length in second direction (a height direction) z of each fold-back portion of external electrode 30 arranged on the bottom surface side, when mounting with solder, an joint area between solder and external electrode 30 can be increased and the strength of securing between a mount substrate and multilayer ceramic capacitor 10 can be improved.

External electrode 30 includes an underlying electrode layer 32 arranged on a surface of multilayer body 12 and a plated layer 34 arranged to cover underlying electrode layer 32.

Underlying electrode layer 32 includes a first underlying electrode layer 32a, a second underlying electrode layer 32b, and a third underlying electrode layer 32c.

Plated layer 34 includes a first plated layer 34a, a second plated layer 34b, and a third plated layer 34c.

In other words, first external electrode 30a includes first underlying electrode layer 32a and first plated layer 34a. Second external electrode 30b includes second underlying electrode layer 32b and second plated layer 34b. Third external electrode 30c includes third underlying electrode layer 32c and third plated layer 34c.

First underlying electrode layer 32a is arranged on a surface of fifth surface 12e of multilayer body 12 and extends from fifth surface 12e to cover a portion of each of first surface 12a and second surface 12b.

Second underlying electrode layer 32b is arranged on the surface of fifth surface 12e of multilayer body 12 and extends from fifth surface 12e to cover a portion of each of first surface 12a, second surface 12b, and third surface 12c.

Third underlying electrode layer 32c is arranged on the surface of fifth surface 12e of multilayer body 12 and extends from fifth surface 12e to cover a portion of each of first surface 12a, second surface 12b, and fourth surface 12d.

Underlying electrode layer 32 includes at least one of, for example, a baked layer, a conductive resin layer, a thin-film layer, or the like.

A configuration in each case where underlying electrode layer 32 is the baked layer, the conductive resin layer, or the thin-film layer will be described below.

### Case of Baked Layer

The baked layer includes a glass component and a metallic component. The glass component of the baked layer includes, for example, at least one of B, Si, Ba, Mg, Al, Li, or the like. The metallic component of the baked layer includes, for example, at least one of Cu, Ni, Ag, Pd, Ag—Pd alloy, Au, or the like. The baked layer may include a plurality of layers. The baked layer is obtained by, for example, applying a conductive paste including the glass component and the metallic component to multilayer body 12 and baking the conductive paste. The baked layer may be obtained by simultaneous firing of a multilayer chip including internal electrode layer 16 and dielectric layer 14 and the conductive paste applied to the multilayer chip, or by firing the multilayer chip including internal electrode layer 16 and dielectric layer 14 to obtain multilayer body 12 and thereafter applying the conductive paste to multilayer body 12 and baking the conductive paste. In an example where the baked layer is obtained by simultaneous firing of the multilayer chip including first internal electrode layer 16 and dielectric layer 14 and the conductive paste applied to the multilayer chip, the baked layer is preferably formed by, for example, baking a material obtained by addition of a dielectric material instead of the glass component.

A thickness in second direction z in which fifth surface 12e and sixth surface 12f are linked, of first underlying electrode layer 32a that is located on fifth surface 12e and extends in layering direction x at the central portion in first direction y in which third surface 12c and fourth surface 12d are linked is, for example, preferably not smaller than about 10 μm and not larger than about 30 μm.

A thickness in second direction z in which fifth surface 12e and sixth surface 12f are linked, of second underlying electrode layer 32b that is located on fifth surface 12e and extends in layering direction x at one end in first direction y in which third surface 12c and fourth surface 12d are linked is, for example, preferably not smaller than about 10 μm and not larger than about 30 μm.

A thickness in second direction z in which fifth surface 12e and sixth surface 12f are linked, of third underlying electrode layer 32c that is located on fifth surface 12e and extends in layering direction x at the other end in first direction y in which third surface 12c and fourth surface 12d are linked is, for example, preferably not smaller than about 10 μm and not larger than about 30 μm.

A thickness in layering direction x in which first surface 12a and second surface 12b are linked at the central portion in first direction y in which third surface 12c and fourth surface 12d are linked, of first underlying electrode layer 32a in first fold-back portion 30a₂ located on a part of first surface 12a and first underlying electrode layer 32a in second fold-back portion 30a₃ located on a part of second surface 12b is, for example, preferably not smaller than about 3 μm and not larger than about 10 μm.

A thickness in layering direction x in which first surface 12a and second surface 12b are linked at the central portion in first direction y in which third surface 12c and fourth surface 12d are linked, of second underlying electrode layer 32b in third fold-back portion 30b₂ located on a part of first surface 12a and second underlying electrode layer 32b in fourth fold-back portion 30b₃ located on a part of second surface 12b is, for example, preferably not smaller than about 3 μm and not larger than about 10 μm.

A thickness in layering direction x in which first surface 12a and second surface 12b are linked at the central portion in first direction y in which third surface 12c and fourth surface 12d are linked, of third underlying electrode layer 32c in sixth fold-back portion 30c₂ located on a part of first surface 12a and third underlying electrode layer 32c in seventh fold-back portion 30c₃ located on a part of second surface 12b is, for example, preferably not smaller than about 3 μm and not larger than about 10 μm.

### Case of Conductive Resin Layer

The conductive resin layer may be arranged on the baked layer to cover the baked layer or may be directly arranged on multilayer body 12 without the baked layer being provided. The conductive resin layer may completely cover the baked layer or cover a portion of the baked layer. Furthermore, the conductive resin layer may include a plurality of layers.

The conductive resin layer includes thermosetting resin and metal. Since the conductive resin layer includes thermosetting resin, it is more flexible than the baked layer made, for example, from a plated film or a fired product of the conductive paste. Therefore, even when physical impact or impact originating from a thermal cycle is applied to multilayer ceramic capacitor 10, the conductive resin layer can function as a buffer layer, and crack to multilayer ceramic capacitor 10 can be prevented.

Ag, Cu, Ni, Sn, or Bi or an alloy including the same, for example, can be used as metal to be included in the conductive resin layer. Metallic powders including surfaces coated with, for example, Ag can also be used. In using metallic powders with surfaces coated with Ag, for example, powders of Cu, Ni, Sn, or Bi or an alloy thereof are preferably used as metallic powders. The reason why conductive metallic powders of Ag are used for conductive metal is that Ag is lowest in specific resistance among metals and thus suitable for an electrode material and Ag is precious metal and hence it is not oxidized and highly weather resistant. In addition, the reason is that, while characteristics of Ag above are maintained, base metal can be inexpensive.

Furthermore, for example, Cu or Ni subjected to antioxidation treatment can also be used as metal to be included in the conductive resin layer. Metallic powders having surfaces coated with, for example, Sn, Ni, or Cu can also be used as metal to be included in the conductive resin layer. In using metallic powders with surfaces coated with Sn, Ni, or Cu, for example, powders of Ag, Cu, Ni, Sn, or Bi or an alloy thereof are preferably used as metallic powders.

Metal included in the conductive resin layer is mainly responsible for an electrical conduction property of the conductive resin layer. Specifically, as conductive fillers come in contact with each other, an electrical conduction path is provided inside the conductive resin layer.

Although metal in a spherical shape, a flat shape, or the like can be included in the conductive resin layer, spherical metallic powders and flat metallic powders are preferably mixed for use.

Various known thermosetting resins such as, for example, epoxy resin, phenol resin, urethane resin, silicone resin, or polyimide resin can be used as resin for the conductive resin layer. Among these resins, for example, epoxy resin excellent in resistance to heat, resistance to moisture, adhesiveness, or the like is one of appropriate resins.

The conductive resin layer preferably includes a hardening agent together with the thermosetting resin. In an example where epoxy resin is used as base resin, various known compounds such as, for example, a phenol based compound, an amine based compound, an acid anhydride based compound, an imidazole based compound, an active ester based compound, or an amide-imide based compound can be used as the hardening agent for epoxy resin.

A largest thickness portion of the conductive resin layer preferably has a thickness, for example, not smaller than about 20 μm and not larger than about 40 μm.

### Case of Thin-Film Layer

In an example where the thin-film layer is provided as underlying electrode layer 32, the thin-film layer is a layer formed with such a thin-film formation method as, for example, sputtering or vapor deposition, and it is a layer, for example, not larger than about 1 μm obtained by deposition of metallic particles.

Plated layer 34 is arranged to cover underlying electrode layer 32.

Plated layer 34 includes at least one of, for example, Cu, Ni, Sn, Ag, Pd, an Ag—Pd alloy, Au, or the like.

Plated layer 34 may include a plurality of layers. In this case, for example, plated layer 34 preferably has a two-layered structure of Ni plating and Sn plating. An Ni plated layer is used to prevent erosion of underlying electrode layer 32 by solder when mounting of multilayer ceramic capacitor 10. An Sn plated layer is used to improve solderability to allow easy mounting of multilayer ceramic capacitor 10. A thickness per one plated layer of plated layers 34 is, for example, preferably not smaller than about 1 μm and not larger than about 6 μm.

External electrode 30 may include only the plated layer without providing underlying electrode layer 32.

A structure where the plated layer is provided without underlying electrode layer 32 being provided will be described below, although it is not shown.

In any or each of first external electrode 30a, second external electrode 30b, and third external electrode 30c, the plated layer may be directly provided on the surface of multilayer body 12 without underlying electrode layer 32 being provided. In other words, multilayer ceramic capacitor 10 may have a structure including the plated layer electrically connected to first internal electrode layer 16a and second internal electrode layer 16b. In such a case, a catalyst may be provided on the surface of multilayer body 12 as pretreatment, and thereafter the plated layer may be formed.

In an example where the plated layer is directly formed on multilayer body 12 without underlying electrode layer 32 being provided, a decrease in thickness corresponding to an absence of underlying electrode layer 32 can result in a lower profile, that is, a smaller thickness, or into a thickness of multilayer body 12, that is, a thickness of capacitance generating portion 18, and thus a degree of freedom in design of a small-thickness chip can be improved.

The plated layer preferably includes a lower plated electrode provided on the surface of multilayer body 12 and an upper plated electrode provided on a surface of the lower plated electrode. The lower plated electrode and the upper plated electrode each preferably include at least one metal of, for example, from Cu, Ni, Sn, Pb, Au, Ag, Pd, Bi, Zn, or the like or an alloy including the metal. Furthermore, the lower plated electrode preferably includes, for example, Ni that defines and functions as a barrier against solder and the upper plated electrode preferably includes, for example, Sn or Au which has excellent solderability.

For example, in an example where first internal electrode layer 16a and second internal electrode layer 16b are made of Ni, the lower plated electrode is preferably made of Cu which joins well to Ni. The upper plated electrode should only be formed as necessary, and each of first external electrode 30a, second external electrode 30b, and third external electrode 30c may be formed only from the lower plated electrode. The plated layer may include the upper plated electrode as an outermost layer, or another plated electrode may further be provided on a surface of the upper plated electrode.

In an example where external electrode 30 includes only the plated layer without underlying electrode layer 32 being provided, a thickness per one plated layer of the plated layers arranged without underlying electrode layer 32 being provided is, for example, preferably not smaller than about 1 μm and not larger than about 15 μm.

Furthermore, the plated layer preferably does not include glass. A ratio of metal per unit volume of the plated layer is, for example, preferably not lower than about 99 volume %.

A dimension in first direction y of multilayer ceramic capacitor 10 including multilayer body 12 and external electrode 30 is defined as an L dimension. The L dimension is, for example, preferably not smaller than about 0.60 mm and not larger than about 1.30 mm.

A dimension in second direction z of multilayer ceramic capacitor 10 including multilayer body 12 and external electrode 30 is defined as a T dimension. The T dimension is, for example, preferably not smaller than about 0.50 mm and not larger than about 1.20 mm.

A dimension in layering direction x of multilayer ceramic capacitor 10 including multilayer body 12 and external electrode 30 is defined as a W dimension. The W dimension is, for example, preferably not smaller than about 0.30 mm and not larger than about 0.95 mm.

Since the t dimension of multilayer body 12 is larger than the w dimension thereof in multilayer ceramic capacitor 10 shown in FIG. 1, the capacitance of the multilayer ceramic capacitor can be increased without increasing a mount area.

In multilayer ceramic capacitor 10 shown in FIG. 1, when length h₁ in second direction z of first fold-back portion 30a₂ of first external electrode 30a is longer than d₁/2 which is about a ½ length of length d₁ in first direction y of first fold-back portion 30a₂ and a length in second direction z of second fold-back portion 30a₃ of first external electrode 30a is longer than about a ½ length of the length in first direction y of second fold-back portion 30a₃, the center of gravity of multilayer ceramic capacitor 10 can be low and thus mountability on the mount substrate can be stabilized.

### 2. Method of Manufacturing Multilayer Ceramic Capacitor

A method of manufacturing this multilayer ceramic capacitor will now be described. The method of manufacturing multilayer ceramic capacitor 10 will be described below.

Initially, a dielectric sheet and a conductive paste for an internal electrode are prepared. A ceramic green sheet or the conductive paste for the internal electrode includes a binder (for example, a known organic binder or the like) and a solvent (for example, an organic solvent or the like).

Then, the conductive paste for the internal electrode is printed on the dielectric sheet in a prescribed pattern, for example, by screen printing, gravure printing, or the like. The dielectric sheet where the pattern of the first internal electrode layer has been formed and the dielectric sheet where the pattern of the second internal electrode layer has been formed are thus prepared.

More specifically, for example, gravure printing plates for printing the first internal electrode layer and the second internal electrode layer are prepared so that each internal electrode layer can be printed. In design of a geometry of the internal electrode in the gravure printing plate, a control factor for a thickness, such as a depth of the plate, can be adjusted to make the thickness of the main portion of each internal electrode layer smaller and to make the thickness of the drawn portion larger than that of the main portion. Accordingly, coverage by the main portion can be made smaller, and coverage by the drawn portion can be made larger than coverage by the main portion.

In order to obtain a desired structure, the dielectric sheet where the first internal electrode layer has been printed and the dielectric sheet where the second internal electrode layer has been printed are alternately layered to form a portion to be the capacitance forming portion.

A prescribed number of dielectric sheets where the pattern of the internal electrode layer has not been printed are then layered to form a portion to be second outer layer portion 20b on the side of second surface 12b. Thereafter, the portion to be capacitance forming portion 18 formed through steps described above is layered on the portion to be second outer layer portion 20b. A prescribed number of dielectric sheets where the pattern of the internal electrode layer has not been printed are then layered on the portion to be capacitance forming portion 18 to form first outer layer portion 20a on the side of first surface 12a. A multilayer sheet is thus made.

In succession, the multilayer sheet is pressed in the layering direction with, for example, a hydrostatic press to make a multilayer block.

The multilayer block is then cut into multilayer chips each having a prescribed size. At this time, a corner portion and a ridgeline portion of the multilayer chip may be rounded by, for example, barrel polishing or the like.

The cut multilayer chips are then fired to make multilayer bodies 12. A firing temperature is, for example, preferably not lower than about 900° C. and not higher than about 1400° C., depending on a material for dielectric layer 14 or internal electrode layer 16.

### Underlying Electrode Layer

In succession, first underlying electrode layer 32a of first external electrode 30a, second underlying electrode layer 32b of second external electrode 30b, and third underlying electrode layer 32c of third external electrode 30c are formed on fifth surface 12e of multilayer body 12 obtained by firing.

In an example where the baked layer is formed as underlying electrode layer 32, the conductive paste including the glass component and the metallic component is applied, thereafter baking treatment is performed, and the baked layer is formed as underlying electrode layer 32. A temperature for baking treatment at this time is, for example, preferably not lower than about 700 and not higher than about 900° C. In the present example embodiment, for example, underlying electrode layer 32 is formed from the baked layer.

Various methods can be used as a method of forming the baked layer. For example, a technique to align orientations of multilayer bodies 12 with the use of a camera or a magnet such that fifth surface 12e faces down and to thereafter hold multilayer body 12 with a holding jig, and to apply the conductive paste by extruding the conductive paste through a slit or a hole can be used. In the case of this technique, an amount of extrusion of the conductive paste can be increased to form first underlying electrode layer 32a to third underlying electrode layer 32c not only on fifth surface 12e but also on a portion of first surface 12a and a portion of second surface 12b. In the second external electrode and the third external electrode, by adjusting a position or a size of the slit or the hole through which the conductive paste is extruded, underlying electrode layer 32 can be formed to a portion of third surface 12c and a portion of fourth surface 12d.

The underlying electrode layer can also be formed with, for example, a roller transfer method. In an example where underlying electrode layer 32 of the first external electrode is formed not only on fifth surface 12e but also to a portion of first surface 12a and a portion of second surface 12b with the roller transfer method, underlying electrode layer 32 can be formed to a portion of first surface 12a and a portion of second surface 12b by increasing a pressure in pressing in roller transfer. Furthermore, in the second external electrode and the third external electrode, by adjusting a position or a size of a roller groove for transfer of the conductive paste, underlying electrode layer 32 can be formed to a portion of third surface 12c and a portion of fourth surface 12d.

### Conductive Resin Layer

In an example where underlying electrode layer 32 is formed from the conductive resin layer, the conductive resin layer can be formed with a method below. The conductive resin layer may be formed on a surface of the baked layer, or the conductive resin layer alone may be directly formed on multilayer body 12 without the baked layer being formed.

In forming the conductive resin layer, a conductive resin paste including thermosetting resin and a metallic component is applied to the baked layer or multilayer body 12 and subjected to heat treatment, for example, at a temperature not lower than about 250° C. and not higher than about 550° C., so that the resin is thermally set to form the conductive resin layer. An atmosphere for heat treatment at this time is, for example, preferably an N₂ atmosphere. In order to prevent resin from scattering and preventing various metallic components from being oxidized, a concentration of oxygen is, for example, preferably about 100 ppm or lower.

In applying the conductive resin paste, similarly to the method of forming underlying electrode layer 32 from the baked layer, for example, the technique to apply the conductive resin paste by, for example, extruding the same through the slit or the roller transfer technique can be used.

### Thin-Film Layer

In an example where underlying electrode layer 32 is formed from the thin-film layer, underlying electrode layer 32 can be formed by masking and a thin-film formation method such as, for example, sputtering or vapor deposition at a position where formation of external electrode 30 is desired. Underlying electrode layer 32 formed from the thin-film layer is, for example, a layer not larger than about 1 μm obtained by deposition of metallic particles.

### Plated Layer

External electrode 30 may be formed only from the plated layer without underlying electrode layer 32 being provided. In that case, the external electrode can be formed with an example of a method below.

Finally, plated layer 34 is formed. Plated layer 34 may be formed on the surface of underlying electrode layer 32 or formed directly on multilayer body 12. In the present example embodiment, plated layer 34 is formed on the surface of underlying electrode layer 32. More specifically, for example, on underlying electrode layer 32, the Ni plated layer is formed as a lower plated layer and the Sn plated layer is formed as an upper plated layer. In performing plating treatment, any of electrolytic plating and electroless plating may be used. Electroless plating is disadvantageous in that pretreatment with a catalyst or the like is required in order to improve a plating deposition rate and a process is complicated. Therefore, electrolytic plating is usually used.

Multilayer ceramic capacitor 10 according to the present example embodiment is manufactured as described above.

### 3. Other Modifications of Each Internal Electrode

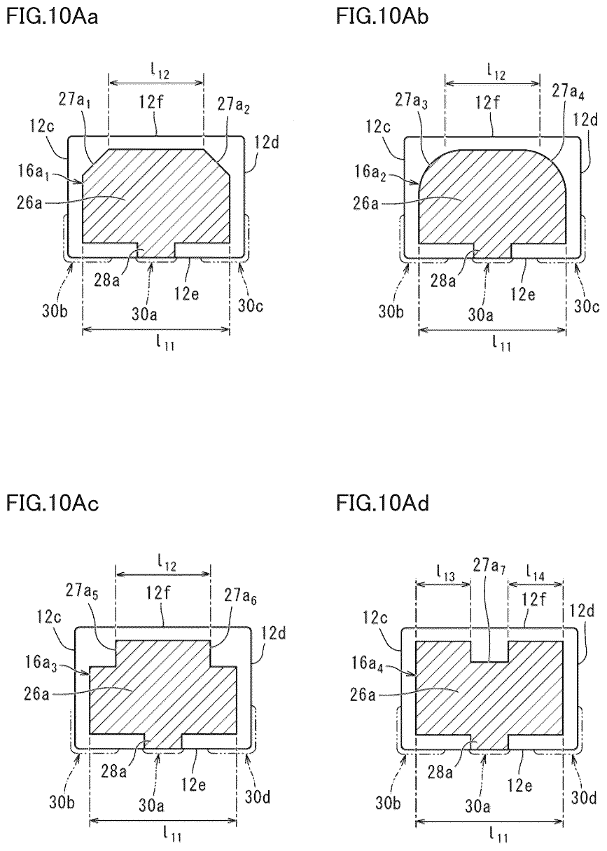

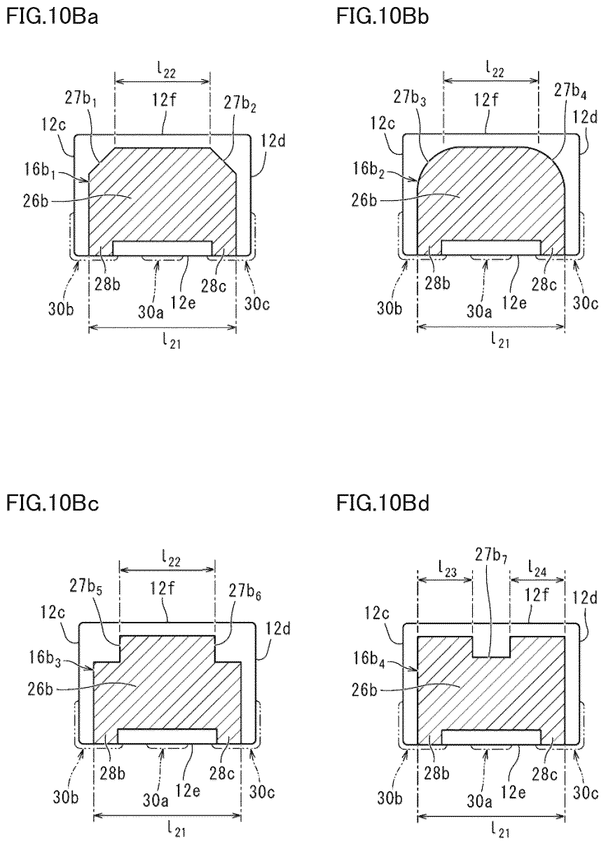

FIG. 10Aa to 10Ad show modifications of first internal electrode layer 16a included in multilayer ceramic capacitor 10 according to example embodiments of the present invention.

A first internal electrode layer 16a₁ shown in FIG. 10Aa includes inclined portions 27a₁ and 27a₂ at opposing corner portions of first main portion 26a on a side of sixth surface 12f such that the length in first direction y of first main portion 26a decreases from fifth surface 12e toward sixth surface 12f. Therefore, in first internal electrode layer 16a₁, a length l₁₁ of a side in first direction y of first main portion 26a on a side of fifth surface 12e is longer than a length l₁₂ of a side in first direction y of first main portion 26a on the side of sixth surface 12f.

A first internal electrode layer 16a₂ shown in FIG. 10Ab includes curved portions 27a₃ and 27a₄ at opposing corner portions of first main portion 26a on the side of sixth surface 12f such that the length in first direction y of first main portion 26a decreases from fifth surface 12e toward sixth surface 12f. Therefore, in first internal electrode layer 16a₂, length l₁₁ of the side in first direction y of first main portion 26a on the side of fifth surface 12e is longer than length l₁₂ of the side in first direction y of first main portion 26a on the side of sixth surface 12f.

A first internal electrode layer 16a₃ shown in FIG. 10Ac includes corner notches 27a₅ and 27a₆ at opposing corner portions of first main portion 26a on the side of sixth surface 12f. Therefore, in first internal electrode layer 16a₃, length l₁₁ of the side in first direction y of first main portion 26a on the side of fifth surface 12e is longer than length l₁₂ of the side in first direction y of first main portion 26a on the side of sixth surface 12f.

A first internal electrode layer 16a₄ shown in FIG. 10Ad includes a notch 27a₇ at an intermediate portion of first main portion 26a on the side of sixth surface 12f. Notch 27a₇ is provided to divide the side in first direction y of first main portion 26a on the side of sixth surface 12f. Therefore, in first internal electrode layer 16a₄, length l₁₁ of the side in first direction y of first main portion 26a on the side of fifth surface 12e is longer than a total length of a length l₁₃ and a length l₁₄ of the side in first direction y of first main portion 26a on the side of sixth surface 12f.

With structures of first internal electrode layers 16a₁ to 16a₄ as shown in FIG. 10Aa to 10Ad, even when multilayer ceramic capacitor 10 including an electrode on the bottom surface side has a higher profile, the center of gravity thereof can be lowered and thus mountability of multilayer ceramic capacitor 10 can be stabilized.

FIG. 10Ba to 10Bd show modifications of second internal electrode layer 16b included in multilayer ceramic capacitor 10 according to example embodiments of the present invention.

A second internal electrode layer 16b₁ shown in FIG. 10Ba includes inclined portions 27b₁ and 27b₂ at opposing corner portions of second main portion 26b on the side of sixth surface 12f such that the length in first direction y of second main portion 26b decreases from fifth surface 12e toward sixth surface 12f. Therefore, in second internal electrode layer 16b₁, a length l₂₁ of a side in first direction y of second main portion 26b on the side of fifth surface 12e is longer than a length l₂₂ of a side in first direction y of second main portion 26b on the side of sixth surface 12f.

A second internal electrode layer 16b₂ shown in FIG. 10Bb includes curved portions 27b₃ and 27b₄ at opposing corner portions of second main portion 26b on the side of sixth surface 12f such that the length in first direction y of second main portion 26b decreases from fifth surface 12e toward sixth surface 12f. Therefore, in second internal electrode layer 16b₂, length l₂₁ of the side in first direction y of second main portion 26b on the side of fifth surface 12e is longer than length l₂₂ of the side in first direction y of second main portion 26b on the side of sixth surface 12f.

A second internal electrode layer 16b₃ shown in FIG. 10Bc includes corner notches 27b₅ and 27b₆ at opposing corner portions of second main portion 26b on the side of sixth surface 12f. Therefore, in second internal electrode layer 16b₃, length l₂₁ of the side in first direction y of second main portion 26b on the side of fifth surface 12e is longer than length l₂₂ of the side in first direction y of second main portion 26b on the side of sixth surface 12f.

A second internal electrode layer 16b₄ shown in FIG. 10Bd includes a notch 27b₇ at an intermediate portion of second main portion 26b on the side of sixth surface 12f. Notch 27b₇ is provided to divide the side in first direction y of second main portion 26b on the side of sixth surface 12f. Therefore, in second internal electrode layer 16b₄, length l₂₁ of the side in first direction y of second main portion 26b on the side of fifth surface 12e is longer than a total length of a length l₂₃ and a length l₂₄ of the side in first direction y of second main portion 26b on the side of sixth surface 12f.

With structures of second internal electrode layers 16b₁ to 16b₄ as shown in FIG. 10Ba to 10Bd, even when multilayer ceramic capacitor 10 including an electrode on the bottom surface side has a higher profile, the center of gravity thereof can be lowered and thus mountability of multilayer ceramic capacitor 10 can be stabilized.

In the description of the example embodiments above, features that can be combined may be combined.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a first surface and a second surface opposed to each other in a layering direction, a third surface and a fourth surface opposed to each other in a first direction orthogonal or substantially orthogonal to the layering direction, and a fifth surface and a sixth surface opposed to each other in a second direction orthogonal or substantially orthogonal to the layering direction and the first direction;
a first external electrode extending in the layering direction at a central portion in the first direction of the fifth surface;
a second external electrode extending in the layering direction at one end in the first direction of the fifth surface; and
a third external electrode extending in the layering direction at an other end in the first direction of the fifth surface; wherein
the multilayer body includes:
a plurality of dielectric layers; and
a plurality of internal electrode layers;
the plurality of internal electrode layers include:
a first internal electrode layer connected to the first external electrode; and
a second internal electrode layer connected to the second external electrode and the third external electrode;
the first external electrode includes a first fold-back portion extending from the fifth surface to a portion of each of the first surface and the second surface;
the second external electrode includes a second fold-back portion extending from the fifth surface to a portion of each of the first surface and the second surface and a third fold-back portion extending to a portion of the third surface;
the third external electrode includes a fourth fold-back portion extending from the fifth surface to a portion of each of the first surface and the second surface and a fifth fold-back portion extending to a portion of the fourth surface; and
a dimension in the second direction of the multilayer ceramic capacitor is greater than a dimension in the layering direction of the multilayer ceramic capacitor.

2. The multilayer ceramic capacitor according to claim 1, wherein a length in the second direction of the first fold-back portion is longer than about ½ length of a length in the first direction of the first fold-back portion.

3. The multilayer ceramic capacitor according to claim 1, wherein
a dimension in the second direction of the second fold-back portion is greater than a dimension in the first direction of the second fold-back portion; and
a dimension in the second direction of the third fold-back portion is greater than a dimension in the first direction of the third fold-back portion.

4. The multilayer ceramic capacitor according to claim 1, wherein a dimension in the second direction of the first fold-back portion is not less than about ⅕ and not greater than about ½ of a dimension in the second direction of the multilayer body.

5. The multilayer ceramic capacitor according to claim 3, wherein a dimension in the second direction of the first fold-back portion is not less than about ⅕ and not greater than about ½ of a dimension in the second direction of the multilayer body.

6. The multilayer ceramic capacitor according to claim 1, wherein
a dimension in the second direction of the second fold-back portion is not less than about ⅕ and not greater than about ½ of a dimension in the second direction of the multilayer body; and
a dimension in the second direction of the third fold-back portion is not less than about ⅕ and not greater than about ½ of the dimension in the second direction of the multilayer body.

7. The multilayer ceramic capacitor according to claim 3, wherein
a dimension in the second direction of the second fold-back portion is not less than about ⅕ and not greater than about ½ of a dimension in the second direction of the multilayer body; and
a dimension in the second direction of the third fold-back portion is not less than about ⅕ and not greater than about ½ of the dimension in the second direction of the multilayer body.

8. The multilayer ceramic capacitor according to claim 5, wherein
a dimension in the second direction of the second fold-back portion is not less than about ⅕ and not greater than about ½ of a dimension in the second direction of the multilayer body; and
a dimension in the second direction of the third fold-back portion is not less than about ⅕ and not greater than about ½ of the dimension in the second direction of the multilayer body.

9. The multilayer ceramic capacitor according to claim 1, wherein a dimension in the first direction of the first external electrode located on the fifth surface is greater than a dimension in the first direction of each of the second external electrode and the third external electrode located on the fifth surface.

10. The multilayer ceramic capacitor according to claim 1, wherein the first internal electrode layer includes inclined portions at opposing corner portions of the first main portion on a side of the sixth surface.

11. The multilayer ceramic capacitor according to claim 1, wherein the first internal electrode layer includes curved portions at opposing corner portions of the first main portion on a side of the sixth surface.

12. The multilayer ceramic capacitor according to claim 1, wherein the first internal electrode layer includes corner notches at opposing corner portions of the first main portion on a side of the sixth surface.

13. The multilayer ceramic capacitor according to claim 1, wherein the first internal electrode layer includes a notch at an intermediate portion of the first main surface on a side of the sixth surface.

14. The multilayer ceramic capacitor according to claim 1, wherein the second internal electrode layer includes inclined portions at opposing corner portions of the second main portion on a side of the sixth surface.

15. The multilayer ceramic capacitor according to claim 1, wherein the second internal electrode layer includes curved portions at opposing corner portions of the second main portion on a side of the sixth surface.

16. The multilayer ceramic capacitor according to claim 1, wherein the second internal electrode layer includes corner notches at opposing corner portions of the second main portion on a side of the sixth surface.

17. The multilayer ceramic capacitor according to claim 1, wherein the second internal electrode layer includes a notch at an intermediate portion of the second main surface on a side of the sixth surface.

18. The multilayer ceramic capacitor according to claim 1, wherein a thickness of each of the plurality of dielectric layers is not smaller than about 0.40 μm and not larger than about 0.75 μm.

19. The multilayer ceramic capacitor according to claim 1, wherein a thickness of each of the first and second internal electrode layers is not smaller than about 0.38 μm and not larger than about 0.60 μm.

20. The multilayer ceramic capacitor according to claim 1, wherein each of the plurality of dielectric layers includes BaTiO₃, CaTiO₃, SrTiO₃, or CaZrO₃.
